(19) United States
(12) Patent Application Publication
(10) Pub. No.: US 2020/0311202 A1
(43) Pub. Date: Oct. 1, 2020

(54) TOXIC CONTENT DETECTION WITH INTERPRETABILITY FEATURE

(71) Applicant: Microsoft Technology Licensing, LLC, Redmond, WA (US)

(72) Inventors: Xiaoran Zhang, Foster City, CA (US); Emilia Stoica, Piedmont, CA (US); Clayton Holz, San Francisco, CA (US)

(21) Appl. No.: 16/370,661

(22) Filed: Mar. 29, 2019

(51) Int. Cl. G06F 17/27; H04L 12/58

(52) U.S. Cl. CPC G06F 17/2775; G06F 17/2705; H04L 51/16

(57) ABSTRACT

Computer-implemented techniques for accurate and interpretable toxic content detection are disclosed. The techniques encompass using a probabilistic toxic keyword identifier to probabilistically determine keywords that are indicative of toxic content. In an implementation, the toxic keywords are determined based on comparing term frequencies of the keywords in a set of example toxic interpersonal electronic communications against term frequencies of the keywords in a set of example non-toxic interpersonal electronic communications. A keyword is determined as indicative of toxic content if its term frequency in the set of toxic examples is more than a threshold number of times more than its term frequency in the set of non-toxic examples. In this way, a set of multiple keywords indicative of toxic content can be determined. Survey comments containing a keyword determined to be toxic are then flagged as potential toxic content in a user interface for human review.

### TECHNICAL FIELD

The present disclosure generally relates to computer-implemented techniques for toxic content detection. More specifically, the present disclosure relates to computer-implemented techniques for toxic content detection where detection of content as toxic is interpretable by a human reviewer.

### BACKGROUND

It can be difficult to assess and improve the health of a company. Company leaders need visibility into employee engagement, insight to focus on what is most important, and guidance to take effective action. To this end, web-based computing platforms exist to solicit and obtain comments from employees. These platforms allow the company to present prompts for comments to employees in a web-based user interface. Using the web-based user interface, the employees can provide anonymous comments about the company and the employment experience in a free-form text format.

Human resources personnel of the company may review the employee-submitted text comments. Such review may be conducted to assess and improve the level of employee engagement. The review may include identifying possible toxicity in the workplace. The company may want to act on identified toxicity to improve and prevent degradation of employee engagement. Toxic comments can include comments that are rude, disrespectful, threatening, obscene, insulting, and contain identity-based hate, to more subtle forms of toxicity that can negatively affect employee engagement such as comments that reflect unethical behavior or a lack of diversity or inclusion/lack of fairness in the workplace.

One challenge for companies using these platforms is simply the amount of comments that may need to be reviewed by a human. Thus, companies would appreciate solutions that help them more quickly identify toxic comments among potentially tens or hundreds of thousands of comments submitted by employees.

One possible solution is to train a deep machine learning classifier to classify comments as to toxicity. For example, a deep neural network-based or support vector-machine-based classifier may be trained to identify toxic comments in a supervised learning fashion based on a set of training examples. However, due to the inherent subjective nature of toxicity, there is a fundamental under specification of the problem of determining what is and what is not a toxic comment that may not be solvable with more training examples or better machine learning algorithms. For example, the lack of consensus between companies and organizations as to what is and what is not toxic content makes it a challenge to compile a set of suitable training examples for a classifier. A given company or organization may have only a few examples of what is considered toxic content and not enough examples to compile a large enough training set to adequately train a classifier.

Because of the under specification of the problem, it is important for users of these web-based computing platforms to be able to explain a decision by the platform that a particular comment is toxic. This importance may stem from a legal requirement to provide an explanation and/or to avoid bias or discrimination against protected groups, for example. Due to the complex nature of deep machine learning systems, a deep machine learning classifier-based solution may not provide the level of interpretability that is needed even though it may be highly accurate in classifying a given test set of comments.

The present invention addresses this and other issues.

The approaches described in this section are approaches that could be pursued, but not necessarily approaches that have been previously conceived or pursued. Therefore, unless otherwise indicated, it should not be assumed that any of the approaches described in this section qualify as prior art, or admitted as well-known, conventional, or routine, merely by virtue of their inclusion in this section.

### BRIEF DESCRIPTION OF THE DRAWINGS

In the drawings:

FIG. 1 depicts probabilistic toxic keyword determination, according to an implementation of the present invention.

FIG. 2 depicts a process for probabilistically determining toxic keywords, according to an implementation of the present invention.

FIG. 3 depicts toxic content detection, according to an implementation of the present invention.

FIG. 4 is a block diagram of an example computer system used in an implementation of the present invention.

### DETAILED DESCRIPTION

In the following description, for the purposes of explanation, numerous specific details are set forth in order to provide a thorough understanding of implementations of the present invention. It will be apparent, however, that an implementation may be practiced without these specific details. In other instances, well-known structures and devices are shown in block diagram form in order to avoid unnecessarily obscuring an implementation.

### General Overview

Computer-implemented techniques for accurate and interpretable toxic content detection are disclosed. The techniques encompass using a probabilistic toxic keyword identifier to probabilistically determine keywords that are indicative of toxic content.

In an implementation, the toxic keywords are determined based on comparing term frequencies of the keywords in a set of example toxic interpersonal electronic communications against term frequencies of the keywords in a set of example non-toxic interpersonal electronic communications. A keyword is determined as indicative of toxic content if its term frequency in the set of toxic examples is more than a threshold number of times more than its term frequency in the set of non-toxic examples. In this way, a set of multiple keywords indicative of toxic content can be determined.

After the set of toxic keywords is determined, electronic survey comments may be parsed and analyzed for containment of toxic keywords. Comments containing a toxic keyword can be flagged in a user interface as potential toxic content.

The techniques are such that determination of the set of toxic keywords and identifying comments as toxic content can be performed automatically by a computing system. As a result, the techniques facilitate a more automated process of identifying toxicity in survey comments. Instead of requiring a human to read and review all survey comments for toxic content—which may number into the many thousands—the review can be limited to those comments automatically flagged as potential toxic content.

Since survey comments are flagged as potential toxic content based on containment of predetermined toxic keywords, a human reviewing a survey comment flagged as potential toxic content can explain why it is flagged as toxic content. In particular, the human can explain that the survey comment is flagged as potential toxic content because it contains one or more keywords that have been predetermined to be indicative of toxic content. Thus, the techniques provide a more interpretable flagging of survey comments as potential toxic content.

What is considered toxic content may vary from company to company. Since, according to the techniques, survey comments are flagged as potential toxic content based on containment of predetermined toxic keywords, if survey comments are being flagged as potential toxic content that a company does not consider to be toxic content, then the keywords causing those survey comments to be flagged can be removed from the set of toxic keywords so that survey comments are no longer flagged as potential toxic content because of those keywords.

At the same time, a keyword that is not included in the set of toxic keywords according to the techniques, but that a company considers indicative of toxic content, can be added to the set of toxic keywords so that survey comments containing the added keyword are flagged as potential toxic content. This flexibility to manually adjust the automatically determined set of toxic keywords to fit a particular company's view of what is and what is not toxic content is possible with the techniques without losing the interpretability feature of the techniques.

Example implementations of the disclosed toxic content detection approach will now be described with reference to the figures.

### Probabilistic Toxic Keyword Determination

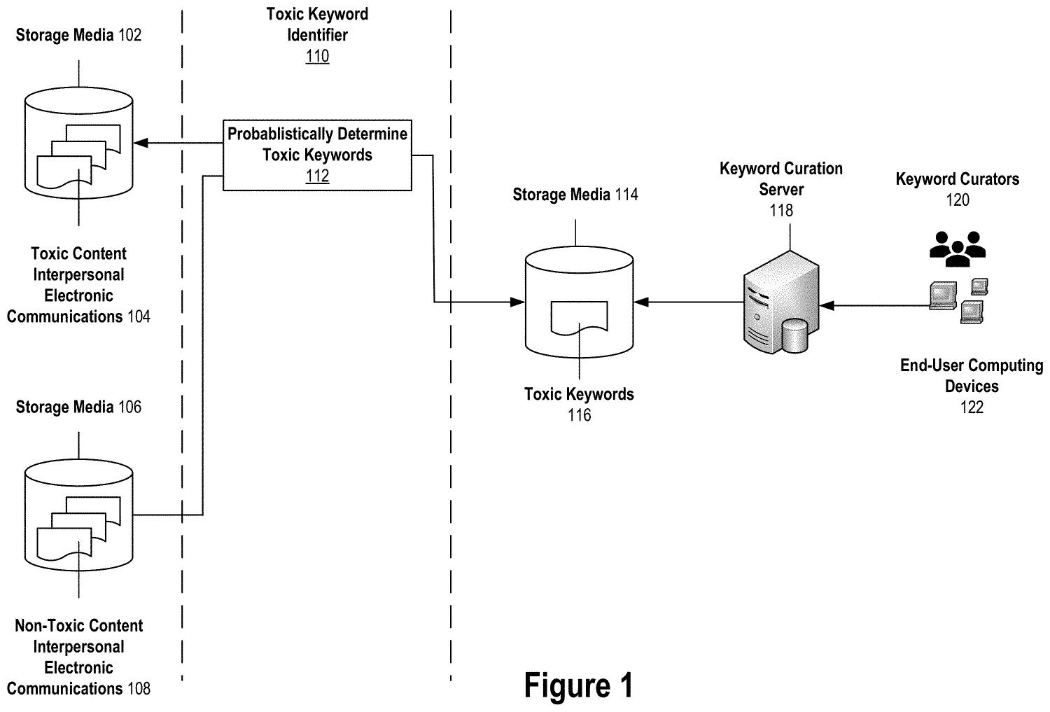

FIG. 1 depicts probabilistic toxic keyword determination according to an implementation of the present invention. At a high-level, toxic keyword identifier 110 probabilistically determines 112 toxic keywords 116 that are indicative of toxic content based on example toxic content interpersonal electronic communications 104 stored in storage media 102 and example non-toxic content interpersonal electronic communications 108 stored in storage media 106.

Identifier 110 stores determined 112 toxic keywords 116 in storage media 114. Keyword curation server 118 allows keywords curators 120 to use a web-based interface at their end-user computing devices 112 to curate toxic keywords 116 including viewing the keywords that identifier 110 probabilistically determined 112 to include in toxic keywords 116, adding new keywords to toxic keywords 116 with user input provided at end-user computing devices 112 that is processed by server 118, and removing selected keywords from toxic keywords 116 with user input provided at end-user computing devices 112 that is processed by server 118.

For example, a keyword curator may enter (e.g., using a soft or physical keyboard at the curator's end-user computing device) the characters of a new keyword to add to toxic keywords 116, or select (e.g., using a pointing device or a touch sensitive surface at the curator's end-user computing device) a keyword to add to toxic keywords 116. The selected keyword may be suggested by server 118 as one to add to toxic keywords 116. The suggestion may be made by server 118 according to an algorithm that identifies keywords for suggestion to add to toxic keywords 116 based on, for example, occurrence in recent employee survey comments determined to be toxic comments. For removing a selected keyword from toxic keywords 116, a keyword curator may select (e.g., using a pointing device or a touch sensitive surface at the curator's end-user computing device) the keyword to remove from among a complete or partial listing of toxic keywords 116.

It should be understood that reference herein to “keyword”, as in, for example, “toxic keyword,” is intended to encompass single words as well as word phrases. A word phrase is a group of words that express a concept and that may be used as a unit within a sentence. There are different types of words (e.g., nouns, verbs, adjectives, adverbs, pronouns, prepositions, conjunctions, etc.). Similarly, there are different types of word phrases (e.g., noun phrases (“the sports car”), verb phrases (“have been sleeping for a long time”), gerund phrases (“going for ice cream”), infinitive phrases (“to donate time or money”), etc.). Thus, toxic keywords 116 are not limited to only single words but may additionally include multi-word key phrases.

When parsing text using a computer such as when parsing text of interpersonal electronic communications and/or text of survey comments, keywords may be identified in text based on a variety of different parsing techniques ranging from the very simple technique of identifying tokens based on separating whitespace or other token separating characters, to the more complex regular expression matching, to sophisticated probabilistic natural language parsing techniques, or a combination of these parsing techniques.

In an implementation, probabilistic natural language parsing techniques in combination with parts-of-speech (POS) tagging are employed to identify keywords in a piece of text such as, for example, in text of an interpersonal electronic communication or text of a survey comment. Examples of probabilistic natural language parsing techniques that may be employed for this purpose are described in the following papers, the entire contents of each of which are hereby incorporated by reference: Danqi Chen and Christopher D Manning, 2014, “A Fast and Accurate Dependency Parser using Neural Networks,” Proceedings of EMNLP 2014; Richard Socher, John Bauer, Christopher D. Manning and Andrew Y. Ng, 2013, “Parsing With Compositional Vector Grammars,” Proceedings of ACL 2013; Dan Klein and Christopher D. Manning, 2003, “Accurate Unlexicalized Parsing,” Proceedings of the 41st Meeting of the Association for Computational Linguistics, pp. 423-430; Dan Klein and Christopher D. Manning, 2003, “Fast Exact Inference with a Factored Model for Natural Language Parsing,” In Advances in Neural Information Processing Systems 15 (NIPS 2002), Cambridge, Mass.: MIT Press, pp. 3-10; “Joakim Nivre, Marie-Catherine de Marneffe, Filip Ginter, Yoav Goldberg, Jan Hajič, Christopher D. Manning, Ryan McDonald, Slav Petrov, Sampo Pyysalo, Natalia Silveira, Reut Tsarfaty, and Daniel Zeman, 2016, “Universal Dependencies v1: A Multilingual Treebank Collection,” In LREC 2016; Sebastian Schuster and Christopher D. Manning, 2016, “Enhanced English Universal Dependencies: An Improved Representation for Natural Language Understanding Tasks,” In LREC 2016; Marie-Catherine de Marneffe, Bill MacCartney and Christopher D. Manning, 2006, “Generating Typed Dependency Parses from Phrase Structure Parses,” In LREC 2006. Another type of probabilistic parser that may be used is the Shift-Reduce Constituency parser by John Bauer, more information for which is available on the internet at /software/srparser.html in the nlp.stanford.edu domain, the entire contents of which is hereby incorporated by reference.

It should be noted that the techniques disclosed herein are not limited to English-only example communications and survey comments and the techniques are compatible with other languages that the parser supports. For example, probabilistic parsing of German, Chinese, Arabic, French, Spanish example communications and survey comments may be supported according to the following papers, the entire contents of each of which is hereby incorporated by reference: Anna Rafferty and Christopher D. Manning, 2008, “Parsing Three German Treebanks: Lexicalized and Unlexicalized Baselines,” In ACL Workshop on Parsing German; Roger Levy and Christopher D. Manning, 2003, “Is it harder to parse Chinese, or the Chinese Treebank?” ACL 2003, pp. 439-446; Pi-Chuan Chang, Huihsin Tseng, Dan Jurafsky, and Christopher D. Manning, 2009, “Discriminative Reordering with Chinese Grammatical Relations Features,” In Proceedings of the Third Workshop on Syntax and Structure in Statistical Translation; Spence Green and Christopher D. Manning, 2010, “Better Arabic Parsing: Baselines, Evaluations, and Analysis,” In COLING 2010; Spence Green, Marie-Catherine de Marneffe, John Bauer, and Christopher D. Manning, 2010, “Multiword Expression Identification with Tree Substitution Grammars: A Parsing tour de force with French,” In EMNLP 2011. The Spanish language may be supported according to the work by Jon Gauthier, more information about which is available on the internet at /software/spanish-faq.html in the nlp.stanford.edu domain, the entire contents of which is hereby incorporated by reference as if full set forth herein.

Storage media 102 may be the same or different storage media as storage media 106. Likewise, with storage media 114 with respect to storage media 102 and/or storage media 106.

Example toxic communications 104 include text of interpersonal electronic communications that are indicative of toxic content. For example, example toxic communications 104 may include text of toxic, severely toxic, obscene, threatening, insulting, and/or identity-based hate interpersonal electronic communications. Example non-toxic communications 108 includes text of interpersonal electronic communications that are not indicative of toxic content.

The text of an interpersonal electronic communication that is included in example toxic communications 104 or example non-toxic communications 108 may include the entire text body the interpersonal electronic communication, or a selected portion thereof. If a selected portion, then the portion selected may include one or more key sentences and/or key phrases extracted from the text body that are deemed to be especially relevant or otherwise summarize the entire text body. For example, a computerized extraction approach may select one or more existing words, phrases, or sentences in the text body of the interpersonal electronic communication to form a text summary. The text summary formed may be included in example toxic communications 104 or example non-toxic communications 108 in lieu of the entire text body of the interpersonal electronic communication.

The computerized extraction approach may be based on a supervised or unsupervised machine learning approach. Non-limiting examples of supervised machine learning approaches that may be used for generating an extractive text summary of an interpersonal electronic communication that may be included in example toxic communications 104 or example non-toxic communications 108 are described in the paper by Peter D. Turney, “Learning Algorithms for Keyphrase Extraction,” Information Retrieval (2000) 2. (4), pp. 303-306, the entire contents of which is hereby incorporated by reference, Non-limiting examples of unsupervised machine learning approaches that may be used for generating an extractive text summary of an interpersonal electronic communication that may be included in example toxic communications 104 or example non-toxic communications 108 are the TextRank and the LexRank algorithms. The TextRank algorithm is described in the paper by R. Mihalcea and P. Tamau, “TextRank: Bringing Order into Texts,” Proceedings of EMNLP-04 and the 2004 Conference on Empirical Methods in Natural Language Processing, (July 2004), the entire contents of which is hereby incorporated by reference. The LexRank algorithm is described in the paper by G, Erkan and D. R. Radev, “LexRank: Graph-based Lexical Centrality as Salience in Text Summarization,” Journal of Artificial Intelligence Research, Vol. 22 (2004), pp. 457-479, the entire contents of which is hereby incorporated by reference.

In addition to, or instead of, an extractive text summarization approach, an abstractive text summarization approach may be used to generate a text summary of an interpersonal electronic communication that is included in example toxic communications 104 or example non-toxic communications 108. For example, a sequence to sequence with attention machine learning model may be used to generate the text summary. One non-limiting example of such a model is the TextSum model for use with Google's Tensor Flow. More information on the TextSum model can be found on the Internet at /tensorflow/models/tree/master/research/textsum in the github.com domain.

It should be noted that since an abstract text summary can include words, sentences, or phrases that are not literally part of the original text, reference herein to text “of” a communication is intended to encompass both text that is extracted from the text contained in the communication and text that is abstracted from the text contained in the communication, unless the context clearly indicates otherwise.

Example toxic communications 104 and example non-toxic communications 108 may be based on text of various different types of interpersonal electronic communications, including a mix of different types, such as, for example, electronic mail messages, social media posts, tweets, survey comments, blog post comments, web article comments, social media news feed comments, or any other electronic communication containing text authored by a person that is intended to be read by one or more other persons. The person authoring the communication, or the person, or persons, for which the communication is intended, need not be known in order for text of the communication to be included in example toxic comments 104 or example non-toxic communications 108. Thus, example toxic communications 104 and example non-toxic communications 108 need not be based only on interpersonal electronic communications that are explicitly addressed to one or more identifiable persons and/or communications by an identifiable author. For example, example toxic communications 104 and example non-toxic communications 108 may include text of anonymous or semi-anonymous communications. Further, while example toxic communications 104 and/or example non-toxic communications 108 may be based on text of human-authored communications, it is also possible for example toxic communications 104 and/or example non-toxic communications 108 to be based on text of machine-generated communications such as, for example, a recurrent neural network-based text generator trained and configured to generate toxic or non-toxic content.

In an implementation, example toxic communications 104 and example non-toxic communications 108 include text of a labeled set of interpersonal electronic communications. In particular, example toxic communications 104 include text of interpersonal electronic communications labeled as toxic, and example non-toxic communications 108 include text of interpersonal electronic communications labeled as non-toxic.

A label may be a binary label, for example. For example, an interpersonal electronic communication may be associated with a single binary label that indicates whether the communication is toxic or non-toxic. If the interpersonal electronic communication is labeled as toxic, then text of the communication may be included in example toxic communications 104.

On the other hand, if the interpersonal electronic communication is not labeled as toxic, then text of the communication may be included in example non-toxic communications 108.

As another example, an interpersonal electronic communication may be associated with a set of multiple binary labels for different sub-categories of toxic content. For example, the different sub-categories of toxic content may include, but are not limited to, toxic, severely toxic, obscene, threatening, insulting, and identity-based hate. In this case, if one or more the toxic sub-category binary labels for an interpersonal electronic communication indicate that the communication is toxic (e.g., one or more of the binary labels each have a “1” value), then text of the communication may be included in example toxic communications 104.

On the other hand, if none of the toxic sub-category binary labels indicate that the interpersonal electronic communication is toxic (e.g., none of the binary values have a “1” value), then text of the communication may be included in example non-toxic communications 108.

Instead of multiple binary labels for different toxic content sub-categories, a single, potentially multi-valued, label can be used instead. For example, an interpersonal electronic communication with text “<obscenity> before you <obscenity> around my work” may be labeled as all of “toxic,” “severely toxic,” “obscene,” and “insulting.” Here, the actual obscenities used in the communication have been replaced with “<obscenity>”. As another example, an interpersonal electronic communication with the text “it's just the damn internet” may be labeled as just “toxic.”

It should be noted that what is considered toxic content and what is not considered toxic content may vary from person to person, organization to organization, and company to company. Indeed, the techniques disclosed herein may successfully operate to detect toxic content with greater interpretability without requiring a particular or a fixed definition of what is toxic content. As such, text of an interpersonal electronic communication that is included in example toxic communications 104 in one implementation may be included in example non-toxic communications 108 in another implementation, and vice versa. Similarly, an interpersonal electronic communication assigned one or more toxic sub-category labels in one implementation may be assigned a different set of toxic sub-category labels in another implementation. For example, one implementation may consider a particular interpersonal electronic communication to be all of: “toxic,” “obscene,” and “insulting” while another implementation may consider the particular communication to be just “toxic” and “obscene.”

Along these lines, text of an individual toxic communication of example toxic communications 104 may be labeled with one or more toxic sub-category labels. The labels may be based on labels assigned to the corresponding interpersonal electronic communication on which the text of the individual toxic communication is based. For example, text of the individual toxic communication of example toxic communications 104 may be associated with a multi-valued label or a set of binary labels indicating one or more toxic sub-categories to which the individual toxic communication is assigned.

In an implementation, toxic sub-category labels associated with example toxic communications 104 are used to further categorize toxic keywords 116 determined based on example toxic communications 104 in toxic sub-categories. This is useful to keyword curators 102 to identify which toxic keywords 116 belong to which toxic sub-categories.

For example, keyword curation server 118 may provide web-based user interfaces at end-user computing devices 122 that allow keyword curators 120 to view all the toxic keywords of toxic keywords 116 that belong to the “obscene” toxic sub-category or the “insulting” toxic sub-category, or to a combination of toxic content sub-categories (e.g., belonging to both the “obscene” and “insulting” sub-categories), etc. The user interfaces may also allow keyword curators 120 to provide user input at devices 112 that is processed by server 118 so that selected toxic keywords of toxic keywords 116 can be moved between different toxic sub-categories or relabeled with different ones of the toxic sub-categories, according to the preferences of keyword curators 120.

### Process for Probabilistically Determining Toxic Keywords

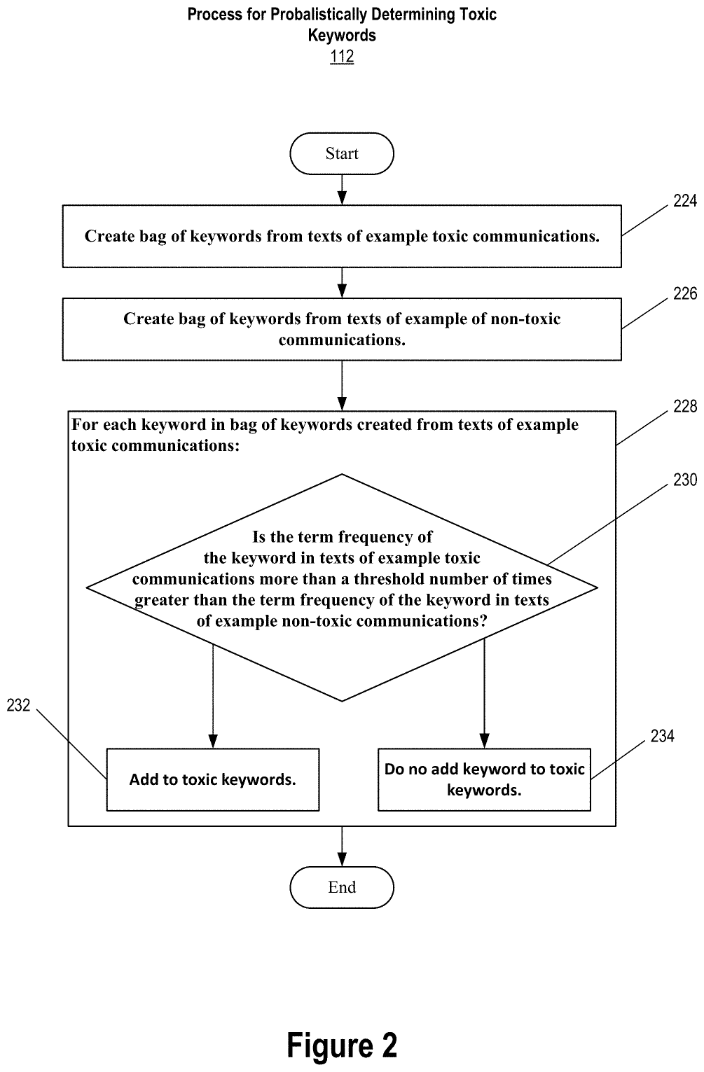

FIG. 2 depicts process 112 for probabilistically determining toxic keywords 116, according to an implementation of the present invention.

At a high level, process 112 begins by creating 224 a bag of keywords from texts of example toxic communications 104. A bag of keywords from texts of example non-toxic communications 108 is also created 226. At operation 228, operation 230 and either operation 232 or operation 234 is performed for each keyword in the bag of keywords created 224 from text of example toxic communications 104. At operation 230, the term frequency of the keyword in texts of example toxic communications 104 is compared 230 against the term frequency of the keyword in texts of example non-toxic communications 108 to determine if the term frequency of the keyword in example toxic communications 104 is at least a threshold number of times greater than the term frequency of the keyword in example non-toxic communications 108. If the term frequency of the keyword in example toxic communications 104 is at least the threshold number of times greater than the term frequency of the keyword in example non-toxic communications 108, then the keyword is included in toxic keywords 116. Otherwise, the keyword is not included in toxic keywords 116 as part of process 112. Process 112 is useful for identifying keywords that are indicative of toxic content, especially keywords that are indicative of more subtle forms of toxicity such as, for example, unethical behavior, or a lack of diversity, lack of inclusion, or lack of fairness in the workplace, assuming toxic communications 104 contain representative example interpersonal electronic communications of these subtler forms of toxicity.

Returning now to the top of process 112, a bag of keywords is created 224 from texts of example toxic communications 104. In doing so, ordering of keywords in the texts of example toxic communications 104 may be ignored. However, the number of occurrences of each keyword in the texts may be counted to determine a term frequency of the keyword in the texts as a collection. Creating 224 the bag of keywords may involve parsing and tokenizing the texts into tokens according to a parsing algorithm. As mentioned above, the parsing algorithm can range from the very simple strategy of identifying tokens based on separating whitespace and removing punctuation, to the more complex regular expression matching, to even more complex probabilistic parsing, or some combination thereof. Common terms such as language-specific stop words (e.g., “a” “an” “and” “are” “as”, “at”, “be”, “by” “for”, “from”, “has”, “he”, “in”, “is”, “it”, “its”, “of”, “on”, “that”, “the”, “to”, “was”, “were”, “will”, “with”, etc. for the English language) may be omitted from the bag of keywords. Although since stop words are typically not indicative of toxic content, it would be expected for the term frequency of a stop word to be approximately equal in both example toxic communications 104 and example non-toxic communications 108. As such, an implementation may skip the step of determining whether a parsed token is a stop word or not for the sake of computational efficiency and at the expense of larger storage media storage space requirements for the created 224 bag of words.

Some or all parsed tokens may be normalized before they are included as keywords in the bag of words. Normalization may involve the use of equivalence classes to account for superficial differences in semantically the same token. For example, the parsed tokens “anti-discriminatory and “antidiscriminatory” may be both mapped to the keyword “antidiscriminatory.” Some or all parsed tokens may be case-folded (i.e., all characters of the token reduced to lowercase). Some or all parsed tokens may be stemmed and/or lemmatized.

For each keyword selected for inclusion in the bag of keywords created 224, a term frequency of the keyword may be computed. The term frequency may be a raw count. The raw count may be number of occurrences of the keyword in the texts of example toxic communications 104.

Another possibility is to adjust for the size/length of the set of example toxic communications 104 by dividing the raw count for the keyword by the total number of communications included in example toxic communications 104.

Other divisors for adjusting for the size/length of the set of example toxic communications 104 are also possible including, for example, the total number of keyword occurrences or the total number of distinct keywords, in the texts of example toxic communications 104.

Another possibility is to compute the term frequency as the base-10 logarithm of the raw count (e.g., term frequency of keyword k=log(1+raw count of keyword k)), such that keywords with very large raw counts do not have outsized term frequencies.

In an implementation, the term frequency of a keyword is computed according to a logarithmic smoothing function that also accounts for the possibility that the keyword may not appear in a set of texts. In particular, the logarithmic smoothing function may be represented as:

tfₖ=p×log p

Here, the term frequency of the keyword k is computed as parameter p multiplied by the log of parameter p. The parameter p represents the number of occurrences of keyword k parsed from a set of texts plus 1 divided by the total number of keyword occurrences or the total number of distinct keywords parsed from the set of texts. As an equation, the parameter p may be represented as:

$$p = \frac{( \# of occurences of keyword k + 1 )}{( total \# of keyword occurences or distinct keywords )}$$

At operation 226, a bag of keywords is created 226 based on the texts of example non-toxic communications 108. The bag of keywords may be created 226 in a manner similar to how bag of keywords for example toxic communications 104 is created 224 except that the bag of keywords is created 226 based on example non-toxic communications 108 instead of example toxic communications 104.

Operations 230 and either operations 232 or operation 234 may be performed for each keyword in the bag of keywords created 224 from the texts of example toxic communications 104. Specifically, the computed term frequency of the current keyword from the texts of example toxic communications 104 is compared 230 against the computed term frequency of the current keyword in the texts of example non-toxic communications 108.

If the computed term frequency of the current keyword in the texts of example toxic communications 104 is more than a threshold number of times greater than the computed term frequency of the current keyword in the texts of example non-toxic communications 108, then the current keyword may be considered indicative of toxic content and included 232 in the set of toxic keywords 116. In an implementation the threshold number of times greater is three times greater. However, this threshold may vary from implementation to implementation, according to the requirements of the particular implementation at hand. For example, the threshold may be determined empirically by running process 112 a number of times using different thresholds and selecting a particular one of the different thresholds that generates a set of toxic keywords that is most representative of toxic content in terms of coverage. Ideally, toxic keywords 116 will include every keyword of example toxic keywords 116 that is indicative of toxic content but not include any keyword that is not indicative of toxic content. Thus, the threshold may be determined empirically by running process 112 multiple times with different thresholds and selecting a threshold that is closest to this ideal.

On the other hand, if the computed term frequency of the current keyword in the texts of example toxic communications 104 is less than the threshold number of times greater than the computed term frequency of the current keyword in the texts of example non-toxic communications 108, then the current keyword may not be considered indicative of toxic content and, accordingly, not included 234 in the set of toxic keywords 116.

While in an implementation a term frequency must be greater than a threshold number in order to be included 232 in toxic keywords 116, the term frequency can be equal to the threshold and still be included 232 in toxic keywords 116 in another implementation.

### Supplementing Toxic Keywords Based on Embeddings

In an implementation, toxic keywords 116 determined by process 112 are supplemented in toxic keywords 116 with additional keywords that are determining according to an embedding function. In particular, for each keyword added 232 to toxic keywords 116, a word vector representation of the keyword is obtained.

The word vector representation may be generated according to an embedding function that is able to compute numeric representations of words in a high-dimensional vector space such that words that are linguistically or semantically similar have close distances in the vector space. Some examples of an embedding function that may be leveraged to obtain word vector representations of keywords is the Word2vec embedding function and the GloVe embedding function. The Word2vec and GloVe embedding functions provide pre-trained word vectors for a vocabulary of words.

However, it is also possible to learn embeddings from a corpus of documents such as, for example, a corpus of survey comments. More information on word vectors and Word2vec is available in the paper by Thomas Mikolov, Kai Chen, Gregory S. Corrado, and Jeffrey Dean, 2013, “Efficient Estimation of Word Representations in Vector Space,” Computing Research Repository, arXiv:1301.3781, the entire contents of which is hereby incorporated by reference. More information on GloVe is available in the paper by Jeffrey Pennington, Richard Socher, and Christopher D. Manning, 2014, “GlOve: Global Vectors for Word Representation,” Proceedings of the 2014 Conference on Empirical Methods in Natural Language Processing (EMNLP),” the entire contents of which is hereby incorporated by reference.

Once a word vector representation of the keyword is obtained, then the N-nearest neighbors to the word vector in the embedding vector space are determined and the words associated with those nearest neighbor vectors are included as part of toxic keywords 116. The nearest neighbors may be determined according to a distance measure such as the cosine similarity between word vectors or a Euclidean distance measure (e.g., L1 or L2 norm) between word vectors. In an implementation, the number of nearest neighbor words of a given keyword that are included in toxic keywords 116 is the words corresponding to the three nearest neighbor word vectors to the word vector for the given keyword in the embedding vector space, but may be as few as one or more than three, according to the requirements of the particular implementation at hand. For example, all nearest neighbor words of a given keyword may be included in toxic keywords 116 up to a predetermined maximum number (e.g., ten) so long as the distance measure between the word vector for the given keyword and a nearest neighbor word vector satisfies a predetermined threshold (i.e., is close enough in the embedding vector space).

For example, process 112 may identify the keyword “discrimination” as indicative as toxic content. As a result, the keyword “discrimination” may be included in toxic keywords 116. In addition, the following three words “retaliation,” “harassment,” and “hostile” may be the three nearest neighbors of keyword “discrimination” in an embedding vector space and, thus, may also be included in toxic keywords 116 because it is linguistically or semantically similar to identified toxic keyword “discrimination.”

### Toxic Content Detection in Survey Comments

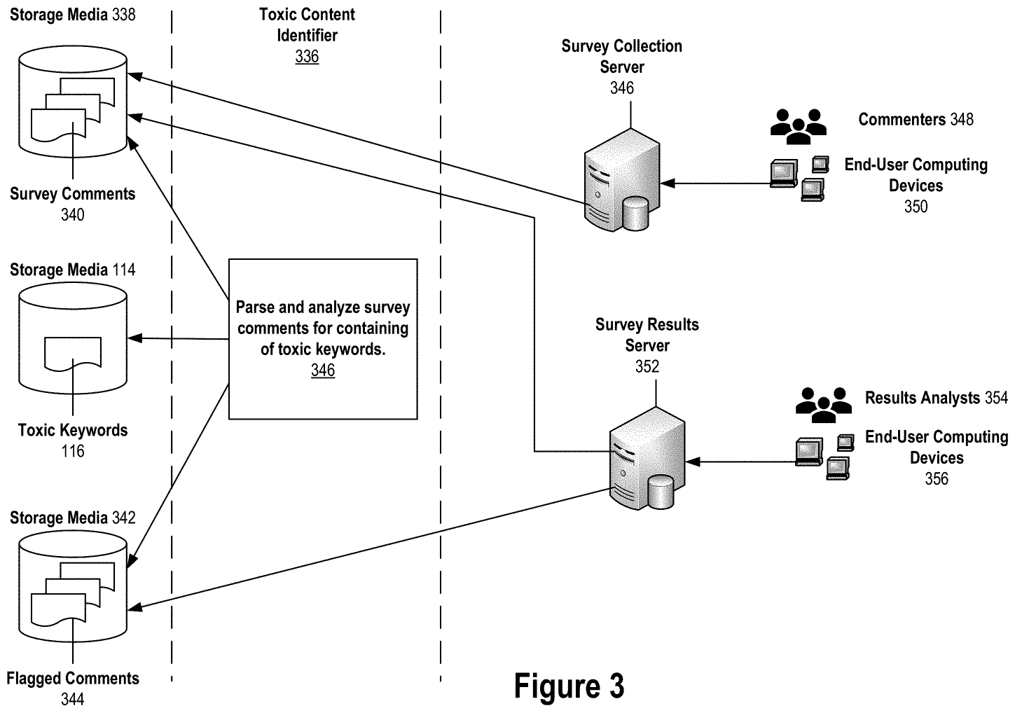

FIG. 3 illustrates toxic content detection in survey comments, according to an implementation of the present invention. Commenters 348 use a web-based user interface (e.g., a web browser-based application or a mobile application) at their end-user personal computing devices 35 to input and submit survey comments to survey collection server 346. Server 346 stores received survey comments as survey comments 340 in storage media 338. Survey comments 340 may encompass text of many survey comments (e.g., tens of thousands or more) submitted by commenters 348.

Toxic content identifier computing system 336 parses and analyzes 346 survey comments 340 for containment of toxic keywords 116 stored in storage media 114. A survey comment of survey comments 340 that contains at least one toxic keyword may be flagged as part of flagged comments 344 in storage media 342. Flagged comments 344 may indicate which of survey comments 340 are flagged as potential toxic content. To do this, flagged comments 344 need not store copies of survey comment in storage media 342 and may instead refer to a particular survey comment in survey comments 340 that is flagged as potential toxic content using an identifier of (or link to) the particular survey comment.

In an implementation, flagged comments 344, as well as identifying survey comments of survey comments 340 that are potential toxic content based on containment of toxic keywords 116, may also include numerical toxic content scores. A numerical toxic content score for a survey comment may reflect the likelihood or probability that the survey comment is toxic content. The toxic content score may be computed based on the number of toxic keywords 116 contained in the survey comment with survey comments having more toxic keywords 116 generally having toxic content scores that reflect a higher probability that the survey comment is toxic content and survey comments have fewer toxic keywords 116 generally having toxic content scores that reflect a lower probability that the survey comment is toxic content. Multiple flagged comments may be ordered/ranked based on their respective toxic comment scores such as, for example, for presentation in order in a user interface that lists the multiple flagged comments.

Survey results analysts 354 may use a web-based interface at their end-user computing devices 356 to review flagged comments 344, or a subset thereof. Flagged comments presented in the user interface may be listed in an order that is based on the respective toxic content scores. In addition, the user interface may indicate, for each of the listed flagged comments, which of the predetermined toxic sub-categories the flagged comment belongs to. The toxic sub-categories that a flagged comment belongs to may be based on which toxic keywords of toxic keywords 116 are contained in the flagged comment. For example, if the flagged comment contains a toxic keyword associated with a particular toxic sub-category, then the flagged comment may be associated with a label for the particular toxic sub-category in the user interface. For example, if the flagged comment contains a toxic keyword associated with the obscene toxic sub-category and another toxic keyword associated with a fairness toxic sub-category, then the flagged comment may be tagged in the user interface as “obscene” and “unfair,” or the like.

### Personally Indicating Information

In an implementation, a survey comment of survey comments 340 is not flagged by toxic content identifier 336 as potential toxic content even though it contains a toxic keyword of toxic keywords 116 unless it also contains personally indicating information. For example, a survey comment of “work is unfair” may be detected as potential toxic content because it contains the toxic keyword “unfair.” However, in an implementation, such a survey comment may not be flagged as part of flagged comments 334 unless it also contains personally indicating information that increases the probability that the survey comment is toxic comment. For example, while survey comment “work is unfair” reflects a general sentiment that is applicable to virtually every workplace, the survey comment “my manager is unfair” suggests that there may be a particular problem beyond the general issue of unfairness in the workplace. Personally indicating information in a survey comment may be identified based on keywords and/or parts-of-speech (POS) tagging of text of the survey comment. The identified keywords and/or parts-of-speech tags may indicate a particular person and/or a particular role or position in an organization. For example, a survey comment that includes a name of a person or a position, role, or job function in an organization. For example, parts-of-speech tagging on the survey comment “my manager is unfair” may be used to identify the pronoun “my” as referring to the commenter and the noun “manager” as referring to the commenter's manager. Based on these parts-of-speech designations, it can be concluded that the survey comment contains personally indicating information. Alternatively, a determination that the survey comment contains personally indicating information may be made based on containment of the keyword “manager” which can refer to a organization role/job function within a company.

### Computing System Implementation

An implementation of the present invention may encompass performance of a method by a computing system having one or more processors and storage media. The one or more processors and the storage media may be provided by one or more computer systems. The storage media of the computing system may store one or more computer programs. The one or more programs may include instructions configured to perform the method. The instructions may also be executed by the one or more processors to perform the method.

An implementation of the present invention may encompass one or more non-transitory computer-readable media. The one or more non-transitory computer-readable media may store the one or more computer programs that include the instructions configured to perform the method.

An implementation of the present invention may encompass the computing system having the one or more processors and the storage media storing the one or more computer programs that include the instructions configured to perform the method.

For an implementation that encompasses multiple computer systems, the computer systems may be arranged in a distributed, parallel, clustered or other suitable multi-node computing configuration in which computer systems are continuously, periodically, or intermittently interconnected by one or more data communications networks (e.g., one or more internet protocol (IP) networks.) Further, it need not be the case that the set of computer systems that execute the instructions be the same set of computer systems that provide the storage media storing the one or more computer programs, and the sets may only partially overlap or may be mutually exclusive. For example, one set of computer systems may store the one or more computer programs from which another, different set of computer systems downloads the one or more computer programs and executes the instructions thereof.

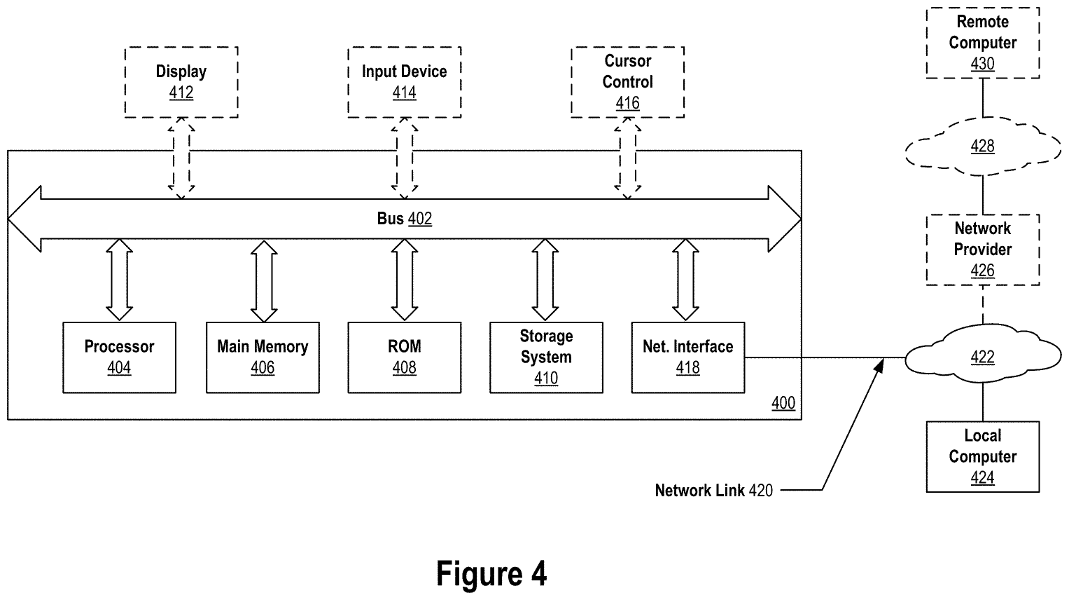

FIG. 4 is a block diagram of example computer system 400 used in an implementation of the present invention. Computer system 400 includes bus 402 or other communication mechanism for communicating information, and one or more hardware processors coupled with bus 402 for processing information.

Hardware processor 404 may be, for example, a general-purpose microprocessor, a central processing unit (CPU) or a core thereof, a graphics processing unit (GPU), or a system on a chip (SoC).

Computer system 400 also includes a main memory 406, typically implemented by one or more volatile memory devices, coupled to bus 402 for storing information and instructions to be executed by processor 404. Main memory 406 also may be used for storing temporary variables or other intermediate information during execution of instructions by processor 404.

Computer system 400 may also include read-only memory (ROM) 408 or other static storage device coupled to bus 402 for storing static information and instructions for processor 404.

A storage system 410, typically implemented by one or more non-volatile memory devices, is provided and coupled to bus 402 for storing information and instructions.

Computer system 400 may be coupled via bus 402 to display 412, such as a liquid crystal display (LCD), a light emitting diode (LED) display, or a cathode ray tube (CRT), for displaying information to a computer user. Display 412 may be combined with a touch sensitive surface to form a touch screen display. The touch sensitive surface may be an input device for communicating information including direction information and command selections to processor 404 and for controlling cursor movement on display 412 via touch input directed to the touch sensitive surface such by tactile or haptic contact with the touch sensitive surface by a user's finger, fingers, or hand or by a hand-held stylus or pen. The touch sensitive surface may be implemented using a variety of different touch detection and location technologies including, for example, resistive, capacitive, surface acoustical wave (SAW) or infrared technology.

Input device 414, including alphanumeric and other keys, may be coupled to bus 402 for communicating information and command selections to processor 404.

Another type of user input device may be cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Instructions, when stored in non-transitory storage media accessible to processor 404, such as, for example, main memory 406 or storage system 410, render computer system 400 into a special-purpose machine that is customized to perform the operations specified in the instructions. Alternatively, customized hard-wired logic, one or more ASICs or FPGAs, firmware and/or hardware logic which in combination with the computer system causes or programs computer system 400 to be a special-purpose machine.

A computer-implemented process may be performed by computer system 400 in response to processor 404 executing one or more sequences of one or more instructions contained in main memory 406. Such instructions may be read into main memory 106 from another storage medium, such as storage system 410. Execution of the sequences of instructions contained in main memory 406 causes processor 404 to perform the process. Alternatively, hard-wired circuitry may be used in place of or in combination with software instructions to perform the process.

The term “storage media” as used herein refers to any non-transitory media that store data and/or instructions that cause a machine to operate in a specific fashion. Such storage media may comprise non-volatile media (e.g., storage system 410) and/or volatile media (e.g., main memory 406). Non-volatile media includes, for example, read-only memory (e.g., EEPROM), flash memory (e.g., solid-state drives), magnetic storage devices (e.g., hard disk drives), and optical discs (e.g., CD-ROM). Volatile media includes, for example, random-access memory devices, dynamic random-access memory devices (e.g., DRAM) and static random-access memory devices (e.g., SRAM).

Storage media is distinct from but may be used in conjunction with transmission media. Transmission media participates in transferring information between storage media. For example, transmission media includes coaxial cables, copper wire and fiber optics, including the circuitry that comprise bus 402. Transmission media can also take the form of acoustic or light waves, such as those generated during radio-wave and infra-red data communications.

Computer system 400 also includes a network interface 418 coupled to bus 402. Network interface 418 provides a two-way data communication coupling to a wired or wireless network link 420 that is connected to a local, cellular or mobile network 422. For example, communication interface 418 may be IEEE 802.3 wired “ethernet” card, an IEEE 802.11 wireless local area network (WLAN) card, an IEEE 802.15 wireless personal area network (e.g., Bluetooth) card or a cellular network (e.g., GSM, LTE, etc.) card to provide a data communication connection to a compatible wired or wireless network. In an implementation, communication interface 418 sends and receives electrical, electromagnetic or optical signals that carry digital data streams representing various types of information.

Network link 420 typically provides data communication through one or more networks to other data devices. For example, network link 420 may provide a connection through network 422 to local computer system 424 that is also connected to network 422 or to data communication equipment operated by a network access provider 426 such as, for example, an internet service provider or a cellular network provider. Network access provider 426 in turn provides data communication connectivity to another data communications network 428 (e.g., the internet). Networks 422 and 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the networks 422 and 428, network link 420 and communication interface 418. In the internet example, a remote computer system 430 might transmit a requested code for an application program through network 428, network 422 and communication interface 418. The received code may be executed by processor 404 as it is received, and/or stored in storage device 410, or other non-volatile storage for later execution.

### Conclusion

In the foregoing detailed description, implementations of the present invention have been described with reference to numerous specific details that may vary from implementation to implementation. The detailed description and the figures are, accordingly, to be regarded in an illustrative rather than a restrictive sense.

Reference in the detailed description to an implementation of the present invention is not intended to mean that the implementation is exclusive of other disclosed implementations of the present invention, unless the context clearly indicates otherwise. Thus, a described implementation may be combined with one or more other described implementations in a given implementation, unless the context clearly indicates that the implementations are incompatible. Further, the described implementations are intended to illustrate the present invention by example and are not intended to limit the present invention to the described implementations.

In the foregoing detailed description and in the appended claims, although the terms first, second, etc. are, in some instances, used herein to describe various elements, these elements should not be limited by these terms. These terms are only used to distinguish one element from another. For example, a first user interface could be termed a second user interface, and, similarly, a second user interface could be termed a first user interface, without departing from the scope of the various described implementations. The first user interface and the second user interface are both user interfaces, but they are not the same user interface.

As used in the foregoing detailed description and in the appended claims of the various described implementations, the singular forms “a,” “an,” and “the” are intended to include the plural forms as well, unless the context clearly indicates otherwise. As used in the foregoing detailed description and in the appended claims, the term “and/or” refers to and encompasses any and all possible combinations of one or more of the associated listed items.

As used in the foregoing detailed description in the appended claims, the terms “based on,” “according to,” “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

For situations in which implementations discussed above collect information about users, the users may be provided with an opportunity to opt in/out of programs or features that may collect personal information. In addition, in some implementations, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized rather than associated with a particular user. For example, the user preferences or user interactions may be generalized based on user demographics.

1. A computer-implemented method for detecting toxic electronic content, the method comprising:
probabilistically determining, using a probabilistic toxic keyword identifier, a particular keyword as indicative of toxic content based on a term frequency of the particular keyword in (a) a first set of example toxic interpersonal electronic communications and a term frequency of the particular keyword in (b) a second set of example non-toxic interpersonal electronic communications, wherein the probabilistic toxic keyword identifier executes using one or more computer systems;
parsing an electronic survey comment and analyzing one or more keywords thereof, using a toxic content identifier, for containment of the particular keyword probabilistically determined as indicative of toxic content, wherein the toxic content identifier executes using one or more computer systems; and
based on a determination that the electronic survey comment contains the particular keyword probabilistically determined as indicative of toxic content, causing a computer user interface to flag the electronic survey comment as potential toxic content.

2. The computer-implemented method of claim 1, further comprising:
probabilistically determining, using the probabilistic toxic keyword identifier, the particular keyword as indicative of toxic content based on:
comparing the term frequency of the particular keyword in (a) the first set of example toxic interpersonal electronic communications against the term frequency of the particular keyword in (b) the second set of example non-toxic interpersonal electronic communications, and
determining that term frequency of the particular keyword in (a) the first set of example toxic interpersonal electronic communications is at least a threshold number of times greater than the term frequency of the particular keyword in (b) the second set of example non-toxic interpersonal electronic communications.

3. The computer-implemented method of claim 2, wherein the threshold number of times greater is approximately three.

4. The computer-implemented method of claim 1, further comprising:
detecting personally indicating information contained in the electronic survey comment; and
based on the detecting the personally indicating information contained in the electronic survey comment, causing the computer user interface to flag the electronic survey comment as potential toxic content.

5. The computer-implemented method of claim 1, further comprising:
probabilistically determining, using the probabilistic toxic keyword identifier, a second particular keyword as indicative of toxic content based on a term frequency of the second particular keyword in (a) the first set of example toxic interpersonal electronic communications and a term frequency of the second particular keyword in (b) the second set of example non-toxic interpersonal electronic communications;
obtaining, from a set learned word vectors, a nearest neighbor word vector of a word vector representing the second particular keyword, the nearest neighbor word vector representing a third particular keyword;
parsing the electronic survey comment and analyzing keywords thereof, using the toxic content identifier, for containment of the third particular keyword; and
based on determining that the electronic survey comment contains the third particular keyword, causing the computer user interface to flag the electronic survey comment as potential toxic content.

6. The computer-implemented method of claim 1,
probabilistically determining, using the probabilistic toxic keyword identifier, the particular keyword as belonging to a particular sub-category of toxic content based on the term frequency of the particular keyword in (a) the first set of example toxic interpersonal electronic communications and the term frequency of the particular keyword in (b) the second set of example non-toxic interpersonal electronic communications;
wherein (a) the first set of example toxic interpersonal electronic communications is designated as belonging to the particular sub-category of toxic content; and
based on a determination that the electronic survey comment contains the particular keyword probabilistically determined as belonging to the particular sub-category of toxic content, causing the computer user interface to flag the electronic survey comment as potentially belonging to the particular sub-category of toxic content.

7. The computer-implemented method of claim 6, further comprising:
probabilistically determining, using the probabilistic toxic keyword identifier, a second particular keyword as belonging to a second particular sub-category of toxic content based on a term frequency of the second particular keyword in (c) a third set of example toxic interpersonal electronic communications designated as belonging to the second particular sub-category of toxic content and a term frequency of the second particular keyword in a (d) fourth set of example non-toxic interpersonal electronic communications;
wherein (c) the third set of example toxic interpersonal electronic communications is designated as belonging to the second particular sub-category of toxic content; and
based on a determination that the electronic survey comment contains the second particular keyword probabilistically determined as belonging to (c) the second particular sub-category of toxic content, causing the computer user interface to flag the electronic survey comment as potentially belonging to the second particular sub-category of toxic content in addition to flagging the electronic survey comment as potentially belonging to the particular sub-category of toxic content.

8. One or more non-transitory computer-readable media comprising:
one or more computer programs for detecting toxic electronic content, the one or more computer programs including instructions configured for:
probabilistically determining, using a probabilistic toxic keyword identifier, a particular keyword as indicative of toxic content based on a term frequency of the particular keyword in (a) a first set of example toxic interpersonal electronic communications and a term frequency of the particular keyword in (b) a second set of example non-toxic interpersonal electronic communications, wherein the probabilistic toxic keyword identifier executes using one or more computer systems;
parsing an electronic survey comment and analyzing one or more keywords thereof, using a toxic content identifier, for containment of the particular keyword probabilistically determined as indicative of toxic content, wherein the toxic content identifier executes using one or more computer systems; and
based on a determination that the electronic survey comment contains the particular keyword probabilistically determined as indicative of toxic content, causing a computer user interface to flag the electronic survey comment as potential toxic content.

9. The one or more non-transitory computer-readable media of claim 8, wherein the one or more computer programs include instructions configured for:
probabilistically determining, using the probabilistic toxic keyword identifier, the particular keyword as indicative of toxic content based on:
comparing the term frequency of the particular keyword in (a) the first set of example toxic interpersonal electronic communications against the term frequency of the particular keyword in (b) the second set of example non-toxic interpersonal electronic communications, and
determining that term frequency of the particular keyword in (a) the first set of example toxic interpersonal electronic communications is at least a threshold number of times greater than the term frequency of the particular keyword in (b) the second set of example non-toxic interpersonal electronic communications.

10. The one or more non-transitory computer-readable media of claim 9, wherein the threshold number of times greater is approximately three.

11. The one or more non-transitory computer-readable media of claim 8, wherein the one or more computer programs include instructions configured for:
detecting personally indicating information contained in the electronic survey comment; and
based on the detecting the personally indicating information contained in the electronic survey comment, causing the computer user interface to flag the electronic survey comment as potential toxic content.

12. The one or more non-transitory computer-readable media of claim 8, wherein the one or more computer programs include instructions configured for:
probabilistically determining, using the probabilistic toxic keyword identifier, a second particular keyword as indicative of toxic content based on a term frequency of the second particular keyword in (a) the first set of example toxic interpersonal electronic communications and a term frequency of the second particular keyword in (b) the second set of example non-toxic interpersonal electronic communications;
obtaining, from a set learned word vectors, a nearest neighbor word vector of a word vector representing the second particular keyword, the nearest neighbor word vector representing a third particular keyword;
parsing the electronic survey comment and analyzing keywords thereof, using the toxic content identifier, for containment of the third particular keyword; and
based on determining that the electronic survey comment contains the third particular keyword, causing the computer user interface to flag the electronic survey comment as potential toxic content.

13. The one or more non-transitory computer-readable media of claim 8, wherein the one or more computer programs include instructions configured for:
probabilistically determining, using the probabilistic toxic keyword identifier, the particular keyword as belonging to a particular sub-category of toxic content based on the term frequency of the particular keyword in (a) the first set of example toxic interpersonal electronic communications and the term frequency of the particular keyword in (b) the second set of example non-toxic interpersonal electronic communications;
wherein (a) the first set of example toxic interpersonal electronic communications is designated as belonging to the particular sub-category of toxic content; and
based on a determination that the electronic survey comment contains the particular keyword probabilistically determined as belonging to the particular sub-category of toxic content, causing the computer user interface to flag the electronic survey comment as potentially belonging to the particular sub-category of toxic content.

14. The one or more non-transitory computer-readable media of claim 13, wherein the one or more computer programs include instructions configured for:
probabilistically determining, using the probabilistic toxic keyword identifier, a second particular keyword as belonging to a second particular sub-category of toxic content based on a term frequency of the second particular keyword in (c) a third set of example toxic interpersonal electronic communications designated as belonging to the second particular sub-category of toxic content and a term frequency of the second particular keyword in a (d) fourth set of example non-toxic interpersonal electronic communications;
wherein (c) the third set of example toxic interpersonal electronic communications is designated as belonging to the second particular sub-category of toxic content; and
based on a determination that the electronic survey comment contains the second particular keyword probabilistically determined as belonging to (c) the second particular sub-category of toxic content, causing the computer user interface to flag the electronic survey comment as potentially belonging to the second particular sub-category of toxic content in addition to flagging the electronic survey comment as potentially belonging to the particular sub-category of toxic content.

15. A computing system comprising:
one or more processors;
storage media;
one or more computer programs for detecting toxic electronic content, the one or more computer programs stored in the storage media and configured for execution by the one or more processors, the one or more computer programs including instructions configured for:
probabilistically determining, using a probabilistic toxic keyword identifier, a particular keyword as indicative of toxic content based on a term frequency of the particular keyword in (a) a first set of example toxic interpersonal electronic communications and a term frequency of the particular keyword in (b) a second set of example non-toxic interpersonal electronic communications, wherein the probabilistic toxic keyword identifier executes using one or more computer systems;
parsing an electronic survey comment and analyzing one or more keywords thereof, using a toxic content identifier, for containment of the particular keyword probabilistically determined as indicative of toxic content, wherein the toxic content identifier executes using one or more computer systems; and
based on a determination that the electronic survey comment contains the particular keyword probabilistically determined as indicative of toxic content, causing a computer user interface to flag the electronic survey comment as potential toxic content.

16. The computing system of claim 15, wherein the one or more computer programs include instructions configured for:
probabilistically determining, using the probabilistic toxic keyword identifier, the particular keyword as indicative of toxic content based on:
comparing the term frequency of the particular keyword in (a) the first set of example toxic interpersonal electronic communications against the term frequency of the particular keyword in (b) the second set of example non-toxic interpersonal electronic communications, and
determining that term frequency of the particular keyword in (a) the first set of example toxic interpersonal electronic communications is at least a threshold number of times greater than the term frequency of the particular keyword in (b) the second set of example non-toxic interpersonal electronic communications.

17. The computing system of claim 15, wherein the one or more computer programs include instructions configured for:
detecting personally indicating information contained in the electronic survey comment; and
based on the detecting the personally indicating information contained in the electronic survey comment, causing the computer user interface to flag the electronic survey comment as potential toxic content.

18. The computing system of claim 15, wherein the one or more computer programs include instructions configured for:
probabilistically determining, using the probabilistic toxic keyword identifier, a second particular keyword as indicative of toxic content based on a term frequency of the second particular keyword in (a) the first set of example toxic interpersonal electronic communications and a term frequency of the second particular keyword in (b) the second set of example non-toxic interpersonal electronic communications;
obtaining, from a set learned word vectors, a nearest neighbor word vector of a word vector representing the second particular keyword, the nearest neighbor word vector representing a third particular keyword;
parsing the electronic survey comment and analyzing keywords thereof, using the toxic content identifier, for containment of the third particular keyword; and
based on determining that the electronic survey comment contains the third particular keyword, causing the computer user interface to flag the electronic survey comment as potential toxic content.

19. The computing system of claim 15, wherein the one or more computer programs include instructions configured for:
probabilistically determining, using the probabilistic toxic keyword identifier, the particular keyword as belonging to a particular sub-category of toxic content based on the term frequency of the particular keyword in (a) the first set of example toxic interpersonal electronic communications and the term frequency of the particular keyword in (b) the second set of example non-toxic interpersonal electronic communications;
wherein (a) the first set of example toxic interpersonal electronic communications is designated as belonging to the particular sub-category of toxic content; and
based on a determination that the electronic survey comment contains the particular keyword probabilistically determined as belonging to the particular sub-category of toxic content, causing the computer user interface to flag the electronic survey comment as potentially belonging to the particular sub-category of toxic content.

20. The computing system of claim 19, wherein the one or more computer programs include instructions configured for:
probabilistically determining, using the probabilistic toxic keyword identifier, a second particular keyword as belonging to a second particular sub-category of toxic content based on a term frequency of the second particular keyword in (c) a third set of example toxic interpersonal electronic communications designated as belonging to the second particular sub-category of toxic content and a term frequency of the second particular keyword in a (d) fourth set of example non-toxic interpersonal electronic communications;
wherein (c) the third set of example toxic interpersonal electronic communications is designated as belonging to the second particular sub-category of toxic content; and
based on a determination that the electronic survey comment contains the second particular keyword probabilistically determined as belonging to (c) the second particular sub-category of toxic content, causing the computer user interface to flag the electronic survey comment as potentially belonging to the second particular sub-category of toxic content in addition to flagging the electronic survey comment as potentially belonging to the particular sub-category of toxic content.
